(19) United States
(12) Patent Application Publication
(10) Pub. No.: US 2020/0257345 A1
(43) Pub. Date: Aug. 13, 2020

(54) MULTI-PORT POWER SUPPLY APPARATUS AND OPERATION METHOD THEREOF

(71) Applicant: VIA LABS, INC., New Taipei City (TW)

(72) Inventors: Tze-Shiang Wang, New Taipei City (TW); Hui-Neng Chang, New Taipei City (TW)

(73) Assignee: VIA LABS, INC., New Taipei City (TW)

(21) Appl. No.: 16/568,265

(22) Filed: Sep. 12, 2019

Related U.S. Application Data
(60) Provisional application No. 62/804,761, filed on Feb. 13, 2019.

(30) Foreign Application Priority Data
Jun. 19, 2019 (TW) 108121276

(51) Int. Cl. G06F 1/26; H01R 25/00; H01R 13/713; G06F 13/42

(52) U.S. Cl. CPC G06F 1/266; H01R 25/006; G06F 2213/0042; G06F 13/4282; H01R 13/713

(57) ABSTRACT

A multi-port power supply apparatus and an operation method thereof are provided. In an embodiment, the multi-port power supply apparatus includes a plurality of USB ports, a plurality of power converters, and a common control circuit. The USB ports include a first USB port and a second USB port. The power converters are configured to supply power to the USB ports. The common control circuit is configured to obtain power variations of the USB ports, and correspondingly control the power converters to supply power to the USB ports according to the power requirements of the USB ports. The common control circuit dynamically diverts a power difference between a first power of the first USB port at a first time and a second power of the first USB port at a second time to the second USB port.

### CROSS-REFERENCE TO RELATED APPLICATION

This application claims the priority benefits of U.S. provisional application Ser. No. 62/804,761, filed on Feb. 13, 2019, and Taiwan application serial no. 108121276, filed on Jun. 19, 2019. The entirety of each of the above-mentioned patent applications is hereby incorporated by reference herein and made a part of this specification.

### TECHNICAL FIELD

The invention relates to a power supply apparatus, and more particularly, to a multi-port power supply apparatus including a plurality of connecting ports and an operation method thereof.

### BACKGROUND

In general, when a power supply apparatus provides an electric energy to an external device through a USB port, the power supply apparatus has to perform a voltage conversion operation according to a rated specification of the external device, so that an output voltage of the power supply apparatus can satisfy a demand voltage of the external device. The power supply apparatus may include a plurality of connecting ports and a plurality of voltage converters corresponding to the connecting ports to provide powers of different output voltages to a plurality of external devices having different demand voltages at the same time. In any case, once a power configuration between the power supply apparatus and the external device is determined, the output voltage output from the conventional power supply apparatus to the external device will remain unchanged until a connection between the external device and the power supply apparatus is cut off.

On the other hand, the voltage converters of the power supply apparatus convert the same source voltage into different output voltages. In general, this source voltage is fixed (namely, the level of the source voltage does not change as voltage requirements of the connecting ports change). Normally, the fixed level of this source voltage has to be very high in order to satisfy the high voltage requirements of the connecting ports. For instance, if the voltage requirements of the connecting ports fall within a range of 5V to 20V, the fixed level of the source voltage may be 24V. When the voltage requirement of a connecting port is 20V, the voltage converter of this connecting port can convert the source voltage (i.e., 24V) into the output voltage (i.e., 20V). However, during a voltage conversion, as the increase (or decrease) of the voltage is greater, a voltage conversion efficiency of the voltage converter will be lower. For example, when the voltage requirement of a connecting port is 5V, the voltage converter of this connecting port has to reduce the voltage from 24V to 5V. As the voltage converter reduces the voltage from 24V to 5V, the voltage conversion efficiency of the voltage converter is decreased. With the lower voltage conversion efficiency, the unconverted electric energy is lost in the form of heat, and thus heating of the power supply apparatus may occur. Therefore, there is a need to provide a novel power supply apparatus to solve the problem of poor voltage conversion efficiency of the conventional power supply apparatus.

It should be noted that, the content in the paragraph “Description of Related Art” are intended to assist understanding the invention. Part of the content (or all content) disclosed in the paragraph “Description of Related Art” may not be the conventional technology known by a person of ordinary skill in the art. The content disclosed in the paragraph “Description of Related Art” may not mean the content is known by a person of ordinary skill in the art before application of the invention.

### SUMMARY

The invention provides a multi-port power supply apparatus capable of improving the voltage conversion efficiency and an operation method thereof.

An embodiment of the invention provides a multi-port power supply apparatus. The multi-port power supply apparatus includes a plurality of USB ports, a plurality of power converters, and a common control circuit. The USB ports include a first USB port and a second USB port. The power converters are respectively coupled to the USB ports in a one-to-one manner. The power converters are configured to supply power to the USB ports. The common control circuit is coupled to the USB ports to obtain power variations of the USB ports. The common control circuit is configured to correspondingly control the power converters to supply power to the USB ports according to the power requirements of the USB ports. The common control circuit dynamically diverts a power difference between a first power of the first USB port at a first time and a second power of the first USB port at a second time to the second USB port.

An embodiment of the invention provides an operation method of a multi-port power supply apparatus. The multi-port power supply apparatus includes a plurality of USB ports. The USB ports include a first USB port and a second USB port. The operating method includes: obtaining power variations of the USB ports by a common control circuit; correspondingly controlling a plurality of power converters according to power requirements of the USB ports by the common control circuit; respectively supplying power to the USB ports by the power converters in a one-to-one manner according to the control of the common control circuit; and dynamically diverting a power difference between a first power of the first USB port at a first time and a second power of the first USB port at a second time to the second USB port by the common control circuit.

An embodiment of the invention provides a multi-port power supply apparatus. The multi-port power supply apparatus includes a power supply circuit, a plurality of USB ports, a plurality of power converters, and a common control circuit. The power supply circuit configured to provide a source electric energy. The power converters are respectively coupled to the USB ports in a one-to-one manner. The power converters are coupled to the power supply circuit to receive the source electric energy. The power converters supply power to the USB ports. The common control circuit is coupled to the USB ports to obtain power requirements of the USB ports. The common control circuit is configured to correspondingly control the power converters to supply power to the USB ports according to the power requirements of the USB ports. The common control circuit calculates a total power of the USB ports. The common control circuit correspondingly controls the power supply circuit to dynamically adjust a voltage of the source electric energy according to a relation between the total power and a threshold power.

An embodiment of the invention provides an operation method of a multi-port power supply apparatus. The multi-port power supply apparatus includes a plurality of USB ports. The operating method includes: providing a source electric energy to a plurality of power converters by a power supply circuit; obtaining power requirements of the USB ports by a common control circuit; calculating a total power of the USB ports by the common control circuit; correspondingly controlling the power supply circuit to dynamically adjust a voltage of the source electric energy according to a relation between the total power and a threshold power by the common control circuit; correspondingly controlling a plurality of power converters according to power requirements of the USB ports by the common control circuit; and respectively supplying power to the USB ports by the power converters according to the control of the common control circuit.

Based on the above, in various embodiments of the invention, the multi-port power supply apparatus and the operation method can be used to dynamically divert the power difference between the first power at the first time and the second power at the second time of one USB port to another USB port. In certain embodiments of the invention, the multi-port power supply apparatus and the operation method can be used to correspondingly control the power supply circuit to dynamically adjust the voltage value of the source electric energy according to the relation between the total power and the threshold power. As a result, the invention can dynamically improve the voltage conversion efficiency of the multi-port power supply apparatus.

To make the above features and advantages of the invention more comprehensible, several embodiments accompanied with drawings are described in detail as follows.

### BRIEF DESCRIPTION OF THE DRAWINGS

FIG. 1 is a circuit block diagram illustrating a multi-port power supply apparatus according to an embodiment of the invention.

FIG. 2 is a flowchart illustrating an operation method according to a first embodiment of the invention.

FIG. 3 to FIG. 5 are flowcharts illustrating step S230 shown in FIG. 2 according to an embodiment of the invention.

FIG. 6 is a flowchart illustrating an operation method according to a second embodiment of the invention.

FIG. 7 to FIG. 10 are flowcharts illustrating an operation method according to a third embodiment of the invention.

FIG. 11 is a circuit block diagram of a multi-port power supply apparatus according to another embodiment of the invention.

FIG. 12 is a flowchart illustrating a part of step S230 shown in FIG. 2 according to another embodiment of the embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. The term “coupled (or connected)” used in this specification (including claims) may refer to any direct or indirect connection means. For example, “a first device is coupled (connected) to a second device” should be interpreted as “the first device is directly connected to the second device” or “the first device is indirectly connected to the second device through other devices or connection means”. The terms such as “first”, “second” and the like as recited in full text of the specification (including claims) are intended to give the elements names or distinguish different embodiments or scopes, and are not intended to limit an upper limit or a lower limit of the number of the elements nor limit an order of the elements. Moreover, wherever possible, elements/components/steps with same reference numerals represent same or similar parts in the drawings and embodiments. Elements/components/steps with the same reference numerals or names in different embodiments may be cross-referenced.

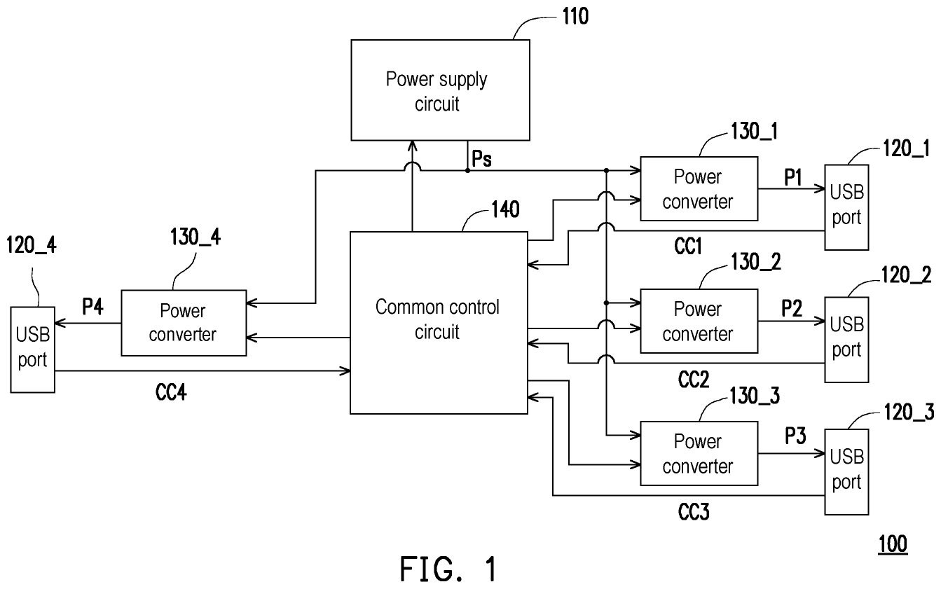

With reference to FIG. 1, FIG. 1 is a circuit block diagram illustrating a multi-port power supply apparatus according to an embodiment of the invention. As shown in FIG. 1, a multi-port power supply apparatus 100 includes a power supply circuit 110, USB ports 120_1 to 120_4, power converters 130_1 to 130_4 and a common control circuit 140. The number of the power converters shown in FIG. 1 is four (i.e., the power converters 130_1 to 130_4), and the number of the USB ports is also four (i.e., the USB ports 120_1 to 120_4). In other embodiments, the number of the power converters and the number of the USB ports may be adjusted/set according to the design requirements.

Based on the design requirements, in certain embodiments, the power supply circuit 110 may include a voltage regulator or other power supply circuit capable of regulating voltage, current and/or power. According to the control of the common control circuit 104, the power supply circuit 110 can convert an external AC electric energy (or DC electric energy) into the DC electric energy (e.g., a source electric energy Ps shown in FIG. 1). The source electric energy Ps provided by the power supply circuit 110 can supply power to the power converters 130_1 to 130_4.

In this embodiment, the multi-port power supply apparatus 100 can supply power to different external devices (not shown) through the different USB ports 120_1 to 120_4, and can obtain configuration information CC1 to CC4 from the different external devices through the different USB ports 120_1 to 120_4. Based on the configuration information CC1 to CC4, the multi-port power supply apparatus 110 can obtain power requirements of these external devices (not shown). For instance, any one of the USB ports 120_1 to 120_4 may be the USB Type-C (or USB-C) port or the USB Type-A port.

The power converters 130_1 to 130_4 are respectively coupled to the USB ports 120_1 to 120_4 in a one-to-one manner. That is to say, an output terminal of the power converter 130_1 is coupled to a power pin (the power bus pin, generally labeled as Vbus) of the USB port 120_1; an output terminal of the power converter 130_2 is coupled to a power pin of the USB port 120_2; an output terminal of the power converter 130_3 is coupled to a power pin of the USB port 120_3; an output terminal of the power converter 130_4 is coupled to a power pin of the USB port 120_4. Input terminals of the power converters 130_1 to 130_4 are respectively coupled to an output terminal of the power supply circuit 110 to receive the source electric energy Ps. According to the control of the common control circuit 140, the power converter 130_1 can convert the source electric energy Ps into an output electric energy P1, and output the output electric energy P1 to the power pin of the corresponding USB port 120_1. According to the control of the common control circuit 140, the power converter 130_2 can convert the source electric energy Ps into an output electric energy P2, and output the output electric energy P2 to the power pin of the corresponding USB port 120_2. According to the control of the common control circuit 140, the power converter 130_3 can convert the source electric energy Ps into an output electric energy P3, and output the output electric energy P3 to the power pin of the corresponding USB port 120_3. According to the control of the common control circuit 140, the power converter 130_4 can convert the source electric energy Ps into an output electric energy P4, and output the output electric energy P4 to the power pin of the corresponding USB port 120_4.

The common control circuit 140 of the multi-port power supply apparatus 100 is coupled to the USB ports 120_1 to 120_4 to obtain the power requirements of the USB ports 120_1 to 120_4. For instance, in certain embodiments, the common control circuit 140 may be coupled to configuration channel (hereinafter, referred to as CC) pins of the USB ports 120_1 to 120_4 to obtain the configuration information CC1 to CC4. Taking the USB port 120_1 as an example, the common control circuit 140 can obtain the configuration information CC1 of the external device (not shown) via the CC pin of the USB port 120_1. The common control circuit 140 can learn a voltage requirement, a current requirement and/or the power requirement of the USB port 120_1 (i.e., the voltage requirement, the current requirement and/or the power requirement of the external device connected to the USB port 120_1) from the configuration information CC1. Similarly, the common control circuit 140 can learn voltage requirements, current requirements and/or the power requirements of the USB ports 120_2 to 120_4 through the configuration information CC2 to CC4 of the USB ports 120_2 to 120_4.

The common control circuit 140 is coupled to control terminals of the power converters 130_1 to 130_4. The common control circuit 140 can support a variety of USB protocols according to the design requirements to cope with transmission requirements of the USB ports 120_1 to 120_4 with different specifications. For instance, when any one of the USB ports 120_1 to 120_4 is the USB Type-C port, the common control circuit 140 may be a USB Type-C Port Controller (TCPC) or a USB Type-C Port Manager (TCPM) that supports the Power Delivery (PD) protocol. As another example, if the USB ports 120_1 to 120_4 are the USB Type-A ports, the power converter 130_1 may be a USB Type-A port manager that supports the

QC (Quick Charge) protocol. As yet another example, when any one of the USB ports 120_1 to 120_4 is connected to an external equipment having a programmable power supply (PPS) function, the common control circuit 140 may support the PPS protocol. The PPS protocol/function is the conventional protocol/function and will not be repeatedly described herein.

The common control circuit 140 controls the power converter 130_1 according to the voltage requirement of the USB port 120_1, so that the power converter 130_1 converts/adjusts the source electric energy Ps into the output electric energy P1 compatible with the voltage requirement. Moreover, the power converter 130_1 outputs the adjusted output electric energy P1 to the power pin of the USB port 120_1. Similarly, the common control circuit 140 controls the power converters 130_2 to 130_4 according to the voltage requirements of the USB ports 120_2 to 120_4, so that the power converters 130_2 to 130_4 output the adjusted output electric energies P2 to P4 to the USB ports 120_2 to 120_4, respectively.

After obtaining the power requirements of the USB ports 120_1 to 120_4, the common control circuit 140 further correspondingly controls the power supply circuit 110 to dynamically adjust a voltage (i.e., a source voltage), a current, and/or a power of the source electric energy Ps according to the power requirements of the USB ports 120_1 to 120_4. For example, by adjusting the voltage of the source electric energy Ps, the common control circuit 140 can reduce a voltage difference between the source electric energy Ps and the output electric energies P1 to P4 as much as possible. In this way, the multi-port power supply apparatus 100 can dynamically adjust the source electric energy Ps according to the power requirements of the USB ports 120_1 to 120_4 to thereby improve the voltage conversion efficiency of the power converters 130_1 to 130_4 of the multi-port power supply apparatus 100.

Based on the different design requirements, the block of the common control circuit 140 may be implemented in form of hardware, firmware, software or a combination of multiples among the three.

In form of hardware, the block of the common control circuit 140 may be implemented as a logic circuit on an integrated circuit. The related functions of the common control circuit 140 may be implemented as hardware using hardware description languages (e.g., Verilog HDL or VHDL) or other suitable programming languages. For instance, the related functions of the common control circuit 140 may be implemented as various logic blocks, modules and circuits in one or more controllers, microcontrollers, microprocessors, application-specific integrated circuits (ASIC), digital signal processors (DSP), field programmable gate arrays (FPGA) and/or other processing units.

In form of software/firmware, the related functions of the common control circuit 140 may be implemented as programming codes. For example, the common control circuit 140 may be implemented using common programming languages (e.g., C or C++) or other suitable programming languages. The programming codes may be recorded/stored in a recording medium. The recording medium includes, for example, a read only memory (ROM), a storage device and/or a random access memory (RAM). A computer, a central processing unit (CPU), a controller, a microcontroller or a microprocessor can read and execute the programming codes from the recording medium to achieve the related functions. A “non-transitory computer readable medium” (including a tape, a disk, a card, a semiconductor memory, a programmable logic circuits, etc.) may be used as the recording medium. Moreover, the programming codes may also be provided to the computer (or the CPU) via any transmission medium (a communication network or a broadcast wave). The communication network is, for example, Internet, a wired communication, a wireless communication or other communication media.

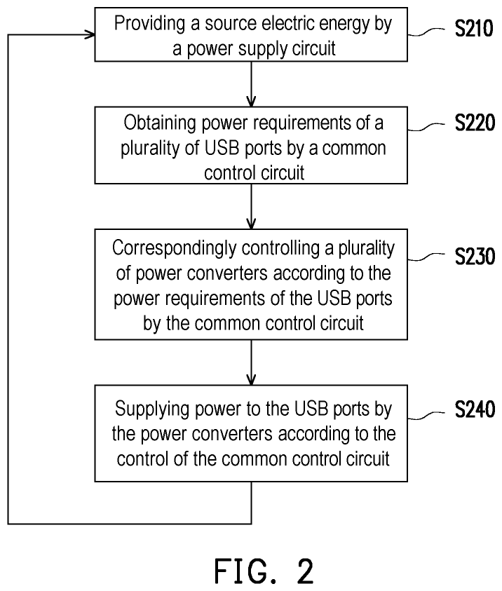

Referring to FIG. 1 and FIG. 2 together, FIG. 2 is a flowchart illustrating an operation method according to the first embodiment of the invention. In the embodiments of FIG. 1 and FIG. 2, the power supply circuit 110 provides the source electric energy Ps to the power converters 130_1 to 130_4 in step S210. In step S220, the common control circuit 140 obtains the power requirements of the USB ports 120_1 to 120_4. The common control circuit 140 can obtain the power requirement of the USB port 120_1 through the configuration information CC1 of the USB port 120_1. Similarly, the common control circuit 140 can obtain the power requirements of the USB ports 120_2 to 120_4 through the configuration information CC2 to CC4 of the USB ports 120_2 to 120_4.

In step S230, the common control circuit 140 correspondingly controls the power converters 130_1 to 130_4 according to the power requirements of the USB ports 120_1 to 120_4. Next, in step S240, the common control circuit 140 controls the power converter 130_1 to convert the source electric energy Ps into the output electric energy P1, so that the power converter 130_1 outputs the output electric energy P1 to the USB port 120_1 to thereby provide the output electric energy P1 to the external device (not shown) connected to the USB port 120_1. Similarly, the power converters 130_2 to 130_4 can convert the source electric energy Ps into the output electric energies P2 to P4 and provide the output electric energies P2 to P4 to the USB ports 120_2 to 120_4.

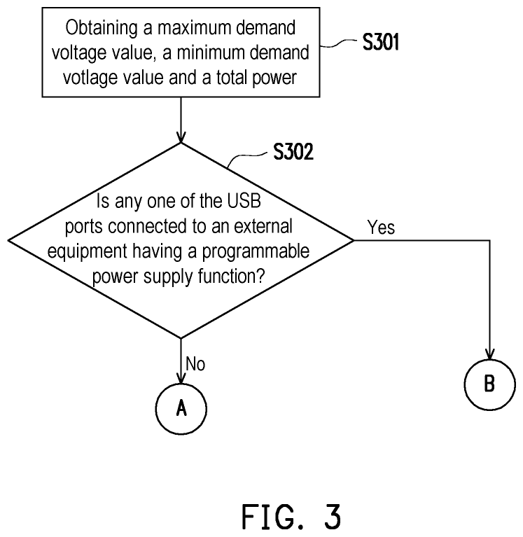

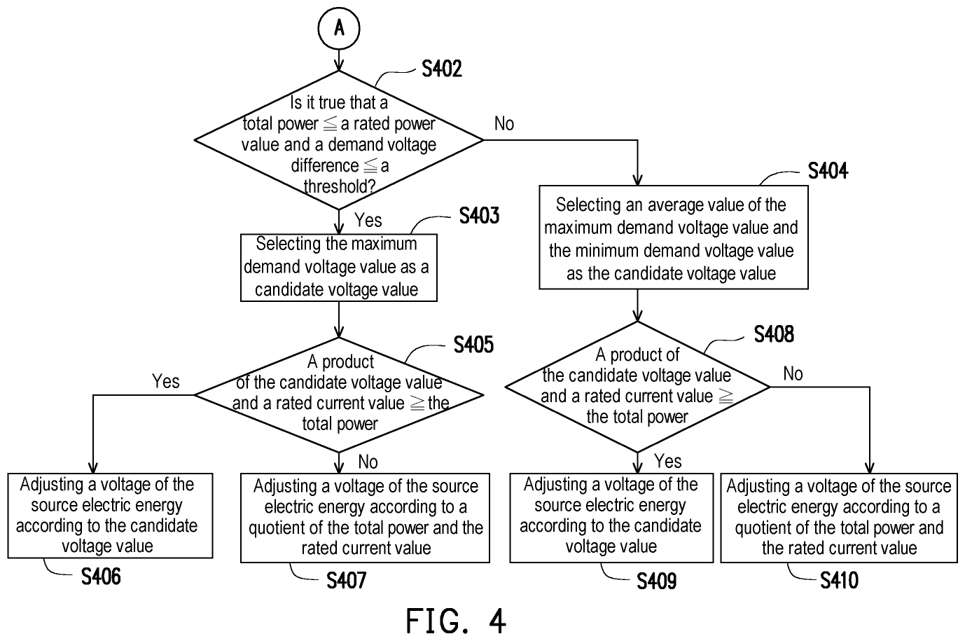

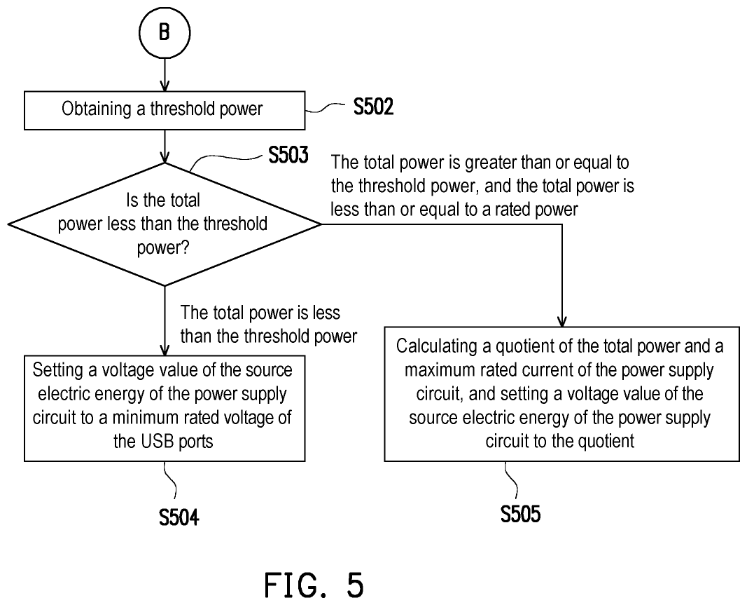

FIG. 3 to FIG. 5 are flowcharts illustrating step S230 shown in FIG. 2 according to an embodiment of the invention. The following refers to FIG. 1, FIG. 3, FIG. 4 and FIG. 5 together. In step S301, the common control circuit 140 can obtain a maximum demand voltage value and a minimum demand voltage value among the voltage requirements of the USB ports 120_1 to 120_4, and calculate a total power according to the power requirements of the USB ports 120_1 to 120_4. The total power may be a sum of the power requirements (maximum powers) of the USB ports 120_1 to 120_4. The maximum demand voltage value may be the largest of these voltage requirements of the USB ports 120_1 to 120_4. The minimum demand voltage value may be the smallest of these voltage requirements of the USB ports 120_1 to 120_4. In the following steps, the common control circuit 140 can calculate a voltage value of the source electric energy Ps according to the maximum demand voltage value, the minimum demand voltage value and the total power.

In this embodiment, the common control circuit 140 can determine whether the USB ports 120_1 to 120_4 are connected to the external equipments having the programmable power supply (PPS) function in step S302. If it is determined in step S302 that none of the USB ports 120_1 to 120_4 is connected to the external equipment having the programmable power supply function, the common control circuit 140 proceeds to step node A. Conversely, if it is determined in step S302 that any one of the USB ports 120_1 to 120_4 is connected to the external equipment having the programmable power supply function, the common control circuit 140 proceeds to step node B.

In this embodiment, after it is determined that none of the USB ports 120_1 to 120_4 is connected to the external equipment having the programmable power supply function in step S302 shown in FIG. 3, the common control circuit 140 can execute step S402 in FIG. 4. In step S402, the common control circuit 140 can determine whether the total power is less than or equal to a rated power value of the power supply circuit 110, and determine whether a difference (i.e., a demand voltage difference) between the maximum demand voltage value and the minimum demand voltage value is less than or equal to a threshold. The threshold may be determined based on the design requirements. The rated power value of the power supply circuit 110 may be a maximum value of an output power (a maximum power of the source electric energy Ps) of the power supply circuit 110. When the common control circuit 140 determines that the total power of the USB ports 120_1 to 120_4 is less than or equal to the rated power value of the power supply circuit 110 and the demand voltage difference is less than or equal to the threshold (i.e., a determination results of step S402 is “Yes”), the common control circuit 140 performs step S403. In step S403, the common control circuit 140 selects the maximum demand voltage value as a candidate voltage value. When the common control circuit 140 determines that the total power of the USB ports 120_1 to 120_4 is greater than the rated power value of the power supply circuit 110 and/or the demand voltage difference is greater than the threshold (i.e., the determination result of step S402 is “No”), the common control circuit 140 performs step S404. In step S404, the common control circuit 140 selects an average value of the maximum demand voltage value and the minimum demand voltage value as the candidate voltage value.

In subsequent steps S405 to S410, the common control circuit 140 calculates the voltage value of the source electric energy Ps according to the candidate voltage value. When the common control circuit 140 determines that a product of the candidate voltage value and a rated current value of the power supply circuit 110 is greater than or equal to the total power of the USB ports 120_1 to 120_4, the common control circuit 140 can adjust the voltage of the source electric energy Ps according to the candidate voltage value. Here, the rated current value of the power supply circuit 110 may be a maximum value of an output current (a maximum current of the source electric energy Ps) of the power supply circuit 110. Conversely, when the common control circuit 140 determines that the product of the candidate voltage value and the rated current value of the power supply circuit 110 is less than the total power of the USB ports 120_1 to 120_4, the common control circuit 140 can adjust the voltage of the source electric energy Ps according to a quotient of the total power and the rated current value.

More specifically, in this embodiment, after selecting the maximum demand voltage value as the candidate voltage value in step S403, the common control circuit 140 can perform step S405. In step S405, the common control circuit 140 further determines whether the product of the candidate voltage value (the maximum demand voltage value) and the rated current value of the power supply circuit 110 is greater than or equal to the total power of the USB ports 120_1 to 120_4. When the product of the maximum demand voltage value and the rated current value is greater than or equal to the total power (i.e., a determination result of step S405 is “Yes”), the common control circuit 140 can perform step S406. In step S406, the common control circuit 140 adjusts the voltage of the source electric energy Ps according to the candidate voltage value (the maximum demand voltage value). For instance, the common control circuit 140 adjusts the voltage value of the source electric energy Ps to the maximum demand voltage value.

Conversely, when the product of the maximum demand voltage value and the rated current value is less than the total power (i.e., the determination result of step S405 is “No”), the common control circuit 140 can perform step S407. In step S407, the common control circuit 140 adjusts the voltage of the source electric energy Ps according to the quotient of the total power and the rated current value. For instance, assuming that the total power of the USB ports 120_1 to 120_4 is H and the rated current value of the power supply circuit 110 is Ir, the common control circuit 140 can adjust the voltage value of the source electric energy Ps to H/Ir.

On the other hand, after selecting the average value of the maximum demand voltage value and the minimum demand voltage value as the candidate voltage value in step S404, the common control circuit 140 can perform step S408. In step S408, the common control circuit 140 determines whether the product of the candidate voltage value (the average value) and the rated current value of the power supply circuit 110 is greater than or equal to the total power. When the product is greater than or equal to the total power (i.e., a determination result of step S408 is “Yes”), the common control circuit 140 can perform step S409. In step S409, the common control circuit 140 adjusts the voltage of the source electric energy Ps according to the candidate voltage value (the average value of the maximum demand voltage value and the minimum demand voltage value). For instance, assuming that the maximum demand voltage value is A and the minimum demand voltage value is B, the average value (the candidate voltage value) will be (A+B)/2. Accordingly, the common control circuit 140 adjusts the voltage value of the source electric energy Ps to (A+B)/2.

Conversely, when the product of the average value (the candidate voltage value) and the rated current value of the power supply circuit 110 is less than the total power (i.e., the determination result of step S408 is “No”), the common control circuit 140 can perform step S410. In step S410, the common control circuit 140 adjusts the voltage of the source electric energy Ps according to the quotient of the total power and the rated current value. For instance, assuming that the total power of the USB ports 120_1 to 120_4 is H and the rated current value of the power supply circuit 110 is Ir, the common control circuit 140 can adjust the voltage value of the source electric energy Ps to H/Ir.

Returning to step S302 shown in FIG. 3, when the common control circuit 140 determines in step S302 that any one of the USB ports 120_1 to 120_4 is connected to the external equipment having the programmable power supply function, the common control circuit 140 can perform step S502 in FIG. 5. In step S02, the common control circuit 140 obtains a threshold power. The threshold power may be determined according to the design requirements. For instance, in certain embodiments, the common control circuit 140 can calculate a product of a minimum rated voltage (e.g., 5V) and a maximum rated current (e.g., 5 A) of the power supply circuit 110 as the threshold power (e.g., 25 W). In step S503, the common control circuit 140 can determine whether the total power H obtained in step S301 is less than the threshold power. When the common control circuit 140 determines in step S503 that the total power H is less than the threshold power, the common control circuit 140 performs step S504 to set the voltage value of the source electric energy Ps of the power supply circuit 110 to the minimum rated voltage (e.g., 5V) of the USB ports 120_1 to 120_4.

When the common control circuit 140 determines in step S503 that the total power H is greater than or equal to the threshold power and the total power H is less than or equal to a rated power that the power supply circuit 110 can provide, the common control circuit 140 performs step S505 to calculate a quotient of the total power H and the maximum rated current of the power supply circuit 110 and set the voltage value of the source electric energy Ps of the power supply circuit 110 to the quotient. For instance, assuming that the maximum rated current of the power supply circuit 110 is 5 A, the common control circuit 140 can set the voltage value of the source electric energy Ps of the power supply circuit 110 to H/5.

Table 1 illustrates a power supply comparison table of the multi-port power supply apparatus according to an embodiment of the invention.

TABLE 1

| | | | | | Total | | Voltage/current |
|---|---|---|---|---|---|---|---|
| Configuration | CC1 | CC2 | CC3 | CC4 | power | | of Ps |
| 1 | 5 V/3 A | 5 V/3 A | 5 V/3 A | 5 V/2.4 A | 57 | W | 11.4 V/5 A |
| 2 | 5 V/3 A | | | | 15 | W | 5 V/3 A |
| 3 | 20 V/3 A | | | | 60 | W | 20 V/3 A |
| 4 | 5 V/3 A | 20 V/2.25 A | | | 60 | W | 12.5 V/4.8 A |
| 5 | 1 V/1 A | 15 V/1 A | 15 V/1 A | 5 V/2.4 A | 57 | W | 11.4 V/5 A |
| 6 | 9 V/1 A | 9 V/1 A | 9 V/1 A | 5 V/2.4 A | 39 | W | 9 V/4.4 A |
| 7 | 5 V/3 A | 9 V/1 A | | | 24 | W | 9 V/2.6 A |
| 8 | 5 V/3 A | 12 V/3 A | | | 51 | W | 10.2 V/5 A |
| 9-1 | 3.3~8.3 V/3 A | | | | <25 | W | 5 V/5 A |
| 9-2 | 8.3~11 V/3 A | | | | ≥25 | W | 5~6.6 V/5 A |
| 10-1 | 3.3~4.3 V/3 A | | | 5 V/2.4 A | <25 | W | 5 V/5 A |
| 10-2 | 4.4~11 V/3 A | | | 5 V/2.4 A | ≥25 | W | 5~9 V/5 A |
| 11-1 | 3.3~4.3 V/1.5 A | 3.3~4.3 V/1.5 A | | 5 V/2.4 A | <25 | W | 5 V/5 A |
| 11-2 | 4.4~11 V/1.5 A | 4.4~11 V/1.5 A | | 5 V/2.4 A | ≥25 | W | 5~9 V/5 A |

Referring to FIG. 1, FIG.3, FIG. 4, FIG. 5 and Table 1 together, in this embodiment, the power supply comparison table of Table 1 lists examples of various configurations. In Configuration 1 to Configuration 8, it is assumed that none of the USB ports 120_1 to 120_4 is connected to the external equipment having the programmable power supply function. In Configuration 9-1, Configuration 9-2, Configuration 10-1, Configuration 10-2, Configuration 11-1 and Configuration 11-2, it is assumed that any one of the USB ports 120_1 to 120_4 is connected to the external equipment having the programmable power supply function. In the embodiment shown by Table 1, the rated power value of the power supply circuit 110 is assumed to be 60 W; the threshold described in step S402 is assumed to be 5V; the rated current value of the power supply circuit 110 is assumed to be 5 A; and the threshold power described in step S502 is 25 W (with the minimum rated voltage preset as 5V).

First of all, with Configuration 1 as an example, through the configuration information CC1 to CC4 of the USB ports 120_1 to 120_4 in Configuration 1, the common control circuit 140 can learn in step S301 that the voltage requirements of the USB ports 120_1 to 120_4 are all 5V and the current requirements of the USB ports 120_1 to 120_4 are 3 A, 3 A, 3 A and 2.4 A, respectively. Therefore, the total power H of the USB ports 120_1 to 120_4 is 5*3+5*3+5*3+5*2.4=57 W. In step S302, because the common control circuit 140 can learn that none of the USB ports 120_1 to 120_4 is connected to the external equipment having the programmable power supply function through the configuration information CC1 to CC4 of the USB ports 120_1 to 120_4, the common control circuit 140 performs steps S402, S403, S405 and S407 in

FIG. 4. In Configuration 2, the common control circuit 140 can learn that a demand voltage of the external device connected to the USB port 120_1 is 5V and a demand current is 3 A through the configuration information CC1, and can also learn that none of the USB ports 120_2 to 120_4 is connected to the external device through the configuration information CC2 to CC4. Therefore, the total power H of the USB ports 120_1 to 120_4 is 5*3+0+0+0=15 W. Accordingly, the common control circuit 140 performs steps S402, S403, S405 and S406 in FIG. 4. Similarly, in Configuration 3, Configuration 6 and Configuration 7, the common control circuit 140 performs steps S402, S403, S405 and S406 in FIG. 4. In Configuration 4, the common control circuit 140 performs steps S402, S404, S408 and S409 in FIG. 4. In Configuration 5 and Configuration 8, the common control circuit 140 performs steps S402, S404, S408 and S410 in FIG. 4.

In Configuration 9-1, the common control circuit 140 can learn in step S302 that the USB port 120_1 is connected to the external equipment having the programmable power supply function through the configuration information CC1 to CC4 of the USB ports 120_1 to 120_4, and proceed to step S502. The common control circuit 140 calculates in step S502 that the total power H is increased from 9.9 W to 24.9 W. In the process described above, the common control circuit 140 determines in step S503 that the total power H is less than the threshold power (e.g., 25 W), and thus proceeds to step S504. The common control circuit 140 sets the voltage value of the source electric energy Ps of the power supply circuit 110 to the minimum rated voltage (i.e., 5V). In addition, the common control circuit 140 sets the current value of the source electric energy Ps of the power supply circuit 110 to the quotient of the threshold power and the minimum rated voltage (i.e., 5 A). In Configuration 9-2, the common control circuit 140 can learn in step S302 that the USB port 120_1 is connected to the external equipment having the programmable power supply function through the configuration information CC1 to CC4 of the USB ports 120_1 to 120_4, and proceed to step S502. The common control circuit 140 calculates in step S502 that the total power H is increased from 24.9 W to 33 W. In the process described above, the common control circuit 140 determines in step S503 that the total power H is greater than the threshold power and the total power H is less than the rated power (60 W), and thus proceeds to step S505. The common control circuit 140 calculates the quotient of the total power H and the maximum rated current (e.g., 5 A) of the power supply circuit, and sets the voltage value of the source electric energy Ps of the power supply circuit 110 to the quotient (i.e., 5V to 6.6V). In addition, the common control circuit 140 sets the current value of the source electric energy Ps of the power supply circuit 110 to 5 A (i.e., the maximum rated current). Here, it is worth noting that, the multi-port power supply apparatus 110 can dynamically adjust the source electric energy Ps in response to the situation where Configuration 9-1 is replaced by Configuration 9-2, thereby dynamically maintaining the high voltage conversion efficiency of the multi-port power supply apparatus.

In Configuration 10-1, an external equipment not having the programmable power supply function is added. However, the common control circuit 140 can learn in step S302 that the USB port 120_1 is connected to the external equipment having the programmable power supply function through the configuration information CC1 to CC4 of the USB ports 120_1 to 120_4, and proceed to step S502. The common control circuit 140 calculates in step S502 that the total power H is increased from 21.9 W to 24.9 W. In the process described above, the common control circuit 140 determines in step S503 that the total power H is less than the threshold power (e.g., 25 W), and thus proceeds to step S504. The common control circuit 140 sets the voltage value of the source electric energy Ps of the power supply circuit 110 to the minimum rated voltage (i.e., 5V). In addition, the common control circuit 140 sets the current value of the source electric energy Ps of the power supply circuit 110 to the quotient of the threshold power and the minimum rated voltage (i.e., 5 A). In Configuration 10-2, the common control circuit 140 calculates in step S502 that the total power H is increased from 25.2 W to 45 W. In the process described above, the common control circuit 140 determines in step S503 that the total power H is greater than the threshold power and the total power H is less than the rated power (60 W), and thus proceeds to step S505. The common control circuit 140 calculates the quotient of the total power H and the maximum rated current (e.g., 5 A) of the power supply circuit, and sets the voltage value of the source electric energy Ps of the power supply circuit 110 to the quotient (i.e., 5V to 9V). In addition, the common control circuit 140 sets the current value of the source electric energy Ps of the power supply circuit 110 to 5 A (i.e., the maximum rated current).

In Configuration 11-1, an external equipment not having the programmable power supply function is added. However, the common control circuit 140 can learn in step S302 that the USB ports 120_1 and 120_2 are connected to the external equipments having the programmable power supply function through the configuration information CC1 to CC4 of the USB ports 120_1 to 120_4, and proceed to step S502. The common control circuit 140 calculates in step S502 that the total power H is increased from 21.9 W to 24.9 W. In the process described above, the common control circuit 140 determines in step S503 that the total power H is less than the threshold power (e.g., 25 W), and thus proceeds to step S504. The common control circuit 140 sets the voltage value of the source electric energy Ps of the power supply circuit 110 to the minimum rated voltage (i.e., 5V). In addition, the common control circuit 140 sets the current value of the source electric energy Ps of the power supply circuit 110 to the quotient of the threshold power and the minimum rated voltage (i.e., 5 A). In Configuration 11-2, the common control circuit 140 calculates in step S502 that the total power H is increased from 25.2 W to 45 W. In the process described above, the common control circuit 140 determines in step S503 that the total power H is greater than the threshold power and the total power H is less than the rated power (60 W), and thus proceeds to step S505. The common control circuit 140 calculates the quotient of the total power H and the maximum rated current (e.g., 5 A) of the power supply circuit, and sets the voltage value of the source electric energy Ps of the power supply circuit 110 to the quotient (i.e., 5V to 9V). In addition, the common control circuit 140 sets the current value of the source electric energy Ps of the power supply circuit 110 to 5 A (i.e., the maximum rated current).

Returning to the embodiment of FIG. 1, in another embodiment, the common control circuit 140 of the multi-port power supply apparatus 100 can further obtain power variations of the USB ports 120_1 to 120_4, and correspondingly control the power converters 130_1 to 130_4 according to the power variations of the USB ports 120_1 to 120_4. In addition, the common control circuit 140 can also divert a power difference between a power at a first time and a power at a second time later than the first time of one of the USB ports 120_1 to 120_4 to other USB port.

In this embodiment, the common control circuit 140 can obtain the power variations of the USB ports 120_1 to 120_4. For instance, a sense resistor (not shown) may be disposed between the USB port 120_1 and the power converter 130_1 so the common control circuit 140 can sense a variation of the current flowing through the USB port 120_1. The common control circuit 140 can deduce the power variation of the USB port 120_1 according to the variation of the current of the USB port 120_1. By analogy, the common control circuit 140 can obtain the power variations of the USB ports 120_2 to 120_4.

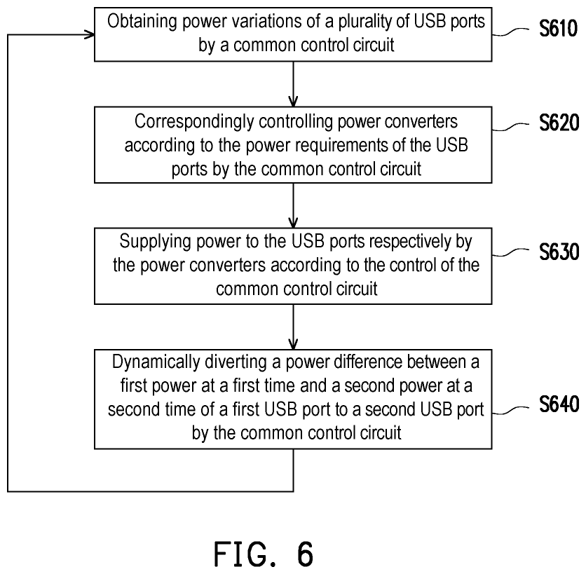

More specifically, the following refers to FIG. 1 and FIG. 6 together. FIG. 6 is a flowchart illustrating an operation method according to a second embodiment of the invention. In this embodiment, the common control circuit 140 obtains the power variations of the USB ports 120_1 to 120_4 in step S610. In step S610, the common control circuit 140 can obtain the power variations of the USB ports 120_1 to 120_4 through the configuration information CC1 to CC4 of the USB ports 120_1 to 120_4. In step S620, the common control circuit 140 correspondingly controls the power converters 130_1 to 130_4 according to the power requirements of the USB ports 120_1 to 120_4. In step S630, the common control circuit 140 controls the power converter 130_1 to convert the source electric energy Ps into the output electric energy P1, so that the power converter 130_1 outputs the output electric energy P1 to the USB port 120_1 to thereby provide the output electric energy P1 to the external device (not shown) connected to the USB port 120_1. Similarly, the power converters 130_2 to 130_4 convert the source electric energy Ps into the output electric energies P2 to P4 and provide the output electric energies P2 to P4 to the USB ports 120_2 to 120_4. According to the power variations of the USB ports 120_1 to 120_4, the common control circuit 140 diverts the power difference between the power at the first time and the power at the second time later than the first time of one of the USB ports 120_1 to 120_4 to one of the other USB ports in step S640. For instance, during a continuous period in which the USB port 120_3 is electrically connected to the external device, the common control circuit 140 controls the power converter 130 3 at the first time so that the power converter 130_3 provides the output electric energy P3 to the USB port 120_3. When the power at the USB port 120_1 is decreased (i.e., the power of the output electric energy P1 at the second time is less than the power of the output electric energy P1 at the first time), the common control circuit 140 controls the power converters 130_1 and 130_3 at the second time to divert the power difference of the USB port 120_1 generated due to the decreased power to the USB port 120_3. Accordingly, the power of the output electric energy P3 is increased (i.e., the power of the output electric energy P3 at the second time will be greater than power of the output electric energy P3 at the first time). In certain embodiments, step S640 may be arranged after step S610.

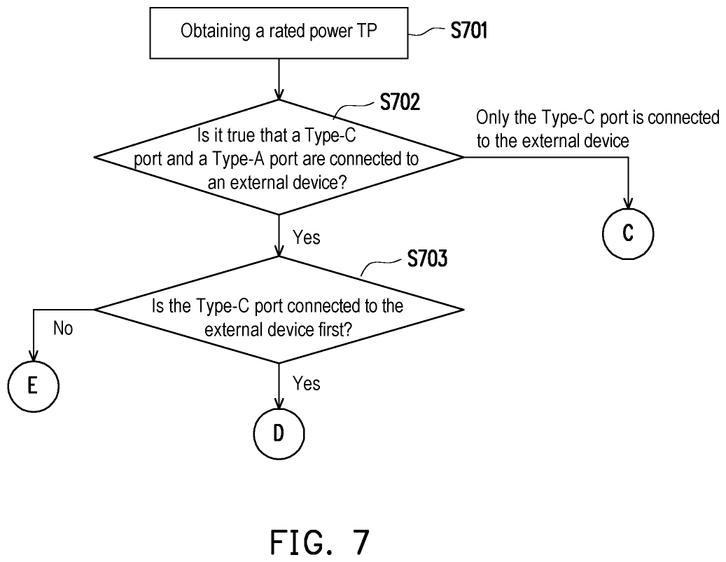

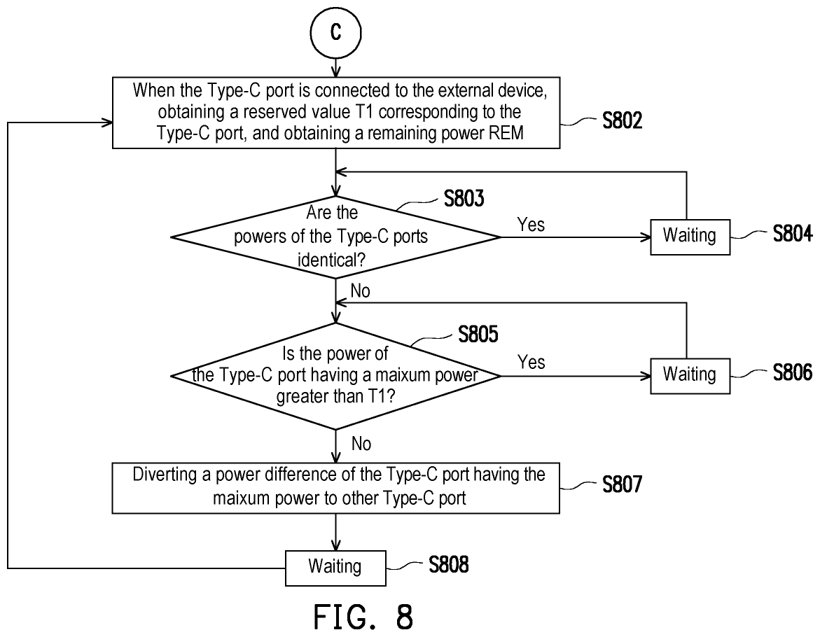

The following refers to FIG. 1, and FIG. 7 to FIG. 10 together. FIG. 7 to FIG. 10 are flowcharts illustrating an operation method according to a third embodiment of the invention. In this embodiment, the common control circuit 140 obtains a rated power TP of the power supply circuit 110 in step S701. In this embodiment, the common control circuit 140 determines whether the USB ports 120_1 to 120_4 are connected to the external devices in step S702 of FIG. 7. In this embodiment, the USB ports 120_1 to 120_3 may be, for example, the Type-C ports. The USB port 120_4 may be, for example, the Type-A port. If it is determined that only at least two of the USB ports 120_1 to 120_3 are respectively connected to the external devices, the common control circuit 140 proceeds to step node C. Next, in step S802 of FIG. 8, when the Type-C port is connected to the external device, the common control circuit 140 obtains a reserved value T1 corresponding to the Type-C port and calculates a remaining power REM by using the rated power of the power supply circuit 110 and the total power. In this embodiment, the reserved value T1 is a product of the minimum rated voltage of the Type-C port and the maximum rated current of the Type-C port. In this embodiment, because the minimum rated voltage of the Type-C port is 5V and the maximum rated current of the Type-C port is 3 A, the reserved value T1 is equal to is 15. The reserved value T1 of the Type-C port is a real number. The remaining power REM is a difference obtained by subtracting the powers of the USB ports connected to the external devices from the rated power TP of the power supply circuit 110.

In step S803, the common control circuit 140 determines whether the powers of the Type-C ports connected to the external devices are identical. The powers being identical mean that there is no need to divert the output electric energy of the Type-C port so that step S804 is then performed. In step S804, the common control circuit 140 waits. For instance, the common control circuit 140 can wait for (but not limit to) 10 minutes before returning to step S803.

In this embodiment, the common control circuit 140 further determines whether the powers of the Type-C ports are greater than a minimum rated power of the Type-C port in step S803. If it is determined that the powers of the Type-C ports are less than or equal to the minimum rated power of the Type-C port, the common control circuit 140 does not perform subsequent operations. If it is determined that the powers of the Type-C ports are greater than the minimum rated power of the Type-C port, the common control circuit 140 can perform the subsequent operations.

In step S803, if it is determined that the powers of the Type-C ports connected to the external devices are different, the common control circuit 140 proceeds to step S805. In step S805, the common control circuit 140 determines whether the power of the Type-C port having a maximum power (i.e., a first USB port) is greater than the reserved value T1 corresponding to the Type-C port. If it is determined that the power of the first USB port is greater than the reserved value T1 corresponding to the Type-C port, the common control circuit 140 proceeds to step S806. In step S806, the common control circuit 140 waits. For instance, the common control circuit 140 can wait for (but not limit to) 10 minutes before returning to step S805. If it is determined that the power of the first USB port is less than or equal to the reserved value T1 corresponding to the Type-C port (i.e., the power of the first USB port is decreased), the common control circuit 140 then proceeds to step S807 to start diverting the power difference of the first USB port to the other USB port (i.e., a second USB port), and proceeds to step S808 once the diverting is completed. In step S808, the common control circuit 140 waits. For instance, the common control circuit 140 can wait for (but not limit to) 10 minutes before returning to step S802.

In step S807, for the USB port 120_1, a voltage value is adjusted to 5V, and a current value is adjusted to 3 A.

In step S807, the common control circuit 140 can also calculate a voltage value and a current value of the new output power by using the power of the first USB port at the first time, the reserved value T1, an original power of the second USB port at the first time and the remaining power REM. The common control circuit 140 controls the power converters 130_1 to 130_4 to configure a new power to the second USB port after the second time. Specifically, the common control circuit 140 can obtain a first reference value according to Equation (1).

N1=(P1′−T1+P2′+REM)/IP Equation (1)

Here, N1 is the first reference value; P1′ is the power of the first USB port at the first time; P2′ is the original power of the second USB port at the first time; and IP is a maximum rated current value. The first reference value may be a positive integer or a positive real number.

Based on the first reference value in different ranges, the common control circuit 140 provides the corresponding voltage value to the Type-C port that receives the power difference after the second time. For instance, when the common control circuit 140 determines that the first reference value is less than or equal to 5, the common control circuit 140 controls the power converters 130_1 to 130_4 to configure the voltage value of 5V to the second USB port. When the common control circuit 140 determines that the first reference value is greater than 5 and less than or equal to 9, the common control circuit 140 controls the power converters 130_1 to 130_4 to configure the voltage value of 5V or 9V to the second USB port. When the common control circuit 140 determines that the first reference value is greater than 9 and less than or equal to 12, the common control circuit 140 controls the power converters 130_1 to 130_4 to configure the voltage value of 5V, 9V or 12V to the second USB port. When the common control circuit 140 determines that the first reference value is greater than 12 and less than or equal to 15, the common control circuit 140 controls the power converters 130_1 to 130_4 to configure the voltage value of 5V, 9V, 12V or 15V to the second USB port. When the common control circuit 140 determines that the first reference value is greater than 15, the common control circuit 140 controls the power converters 130_1 to 130_4 to configure the voltage value of 5V, 9V, 12V, 15V or 20V to the second USB port.

Table 2 illustrates a power supply comparison table of the multi-port power supply apparatus according to an embodiment of the invention.

TABLE 2

| Config- | | | | Remaining | |
|---|---|---|---|---|---|
| uration | CC1 | CC2 | CC3 | power | |
| 12-1 | 5 V/3 A | 5 V/3 A | 5 V/3 A | 15 | W |
| 12-2 | 5 V/3 A | 5 V/3 A | 5 V/3 A | 15 | W |
| 13-1 | 9 V/3 A | 9 V/2.67 A | 9 V/1 A | 0 | W |
| 13-2 | 5 V/3 A | 9 V/2.67 A | 9 V/2.3 A | 0 | W |
| 14-1 | 5 V/3 A | 9 V/2.67 A | 9 V/2.3 A | 0 | W |
| 14-2 | 5 V/3 A | 5 V/3 A | 12 V/2.5 A | 0 | W |
| 15-1 | 15 V/3 A | 9 V/1.5 A | | 1.5 | W |
| 15-2 | 5 V/3 A | 15 V/3 A | | 0 | W |
| 16-1 | 20 V/2.25 A | 9 V/1.5 A | | 1.5 | W |
| 16-2 | 5 V/3 A | 15 V/3 A | | 0 | W |

Examples are provided below for further description. Referring to FIG. 1, FIG. 8 and Table 2 together, with respect to Configuration 12-1 in this example, the common control circuit 140 can determine in step S803 that the powers of the Type-C ports connected to the external devices are identical from the configuration information CC1 to CC3 of Configuration 12-1. Accordingly, after entering Configuration 12-2, there is no need to divert the power difference.

With respect to Configuration 13-1 and Configuration 13-2, from the configuration information CC1 to CC3 of Configuration 13-1, the common control circuit 140 can determine that the powers of the Type-C ports connected to the external devices are different in step S803. Because the configuration information CC1 indicates that the USB port 120_1 is the Type-C port having the maximum power (i.e., 27 W), the common control circuit 140 uses the USB port 120_1 as the first USB port. The configuration information CC3 indicates that the USB port 120_3 is the Type-C port having a minimum power (i.e., 9 W). The common control circuit 140 uses the USB port 120_3 as the second USB port. The common control circuit 140 starts determining whether the power of the USB port 120_1 is decreased from being greater than the reserved value T1 corresponding to the Type-C port to being less than or equal to the reserved value T1 in step S805. If the power of the USB port 120_1 converted from Configuration 13-1 to Configuration 13-2 (i.e., at the second time) is decreased to be less than or equal to the reserved value T1 (i.e., the configuration information CC1 in configuration 13-2), step S807 is performed to divert the power difference to the second USB port (i.e., the USB port 120_3). In step S807, the common control circuit 140 can determine that the power of the USB port 120_1 is decreased from 27 W to 15 W. In other words, the USB port 120_1 has finished or is about to finish charging (or supplying power) the external device. Therefore, the variation of the power decreased from 27 W to 15 W (i.e., 12 W) is used as the power difference. Next, by using the power difference (i.e., 12 W) and the original power of the USB port 120_3 at the second time (i.e., 9 W), the common control circuit 140 calculates the new power (i.e., 9+12=21 W). Accordingly, the power of the USB port 120_3 is increased from 9 W to 21 W. For the USB port 120_1, the voltage value is adjusted to 5V, and the current value is adjusted to 3 A. In Configuration 13-1 and Configuration 13-2, the first reference value equal to 7 may be obtained according to Equation (1). Accordingly, the voltage value of the USB port 120_3 may be 9V. Also, the current value of the USB port 120_3 is a quotient of the new power and the voltage value (i.e., 2.3 A).

With respect to Configuration 14-1 and Configuration 14-2, from the configuration information CC1 to CC3 of Configuration 14-1, the common control circuit 140 can determine that the powers of the Type-C ports connected to the external devices are different in step S803. The configuration information CC2 indicates that the USB port 120_2 is the Type-C port having the maximum power (i.e., 24 W). The common control circuit 140 uses the USB port 120_2 as the first USB port and uses the USB port 120_3 as the second USB port.

The common control circuit 140 can determine in step S805 that the power of the USB port 120_2 converted from Configuration 14-1 to Configuration 14-2 (i.e., at the second time) is decreased to be less than or equal to the reserved value T1, and thus perform step S807 to divert the power difference to the second USB port (i.e., the USB port 120_3). In step S807, the common control circuit 140 can determine that the power of the USB port 120_2 is decreased from 24 W to 15 W. In other words, the USB port 120_2 has finished or is about to finish charging (or supplying power) the external device. Therefore, the variation of the power decreased from 24 W to 15 W (i.e., 9 W) is used as the power difference. Next, by using the power difference (i.e., 9 W) and the original power of the USB port 120_3 at the second time (i.e., 21 W), the common control circuit 140 can calculate the new power (i.e., 21+9=30 W). Accordingly, the power of the USB port 120_3 is increased from 21 W to 30 W. For the USB port 120_2, the voltage value is adjusted to 5V, and the current value is adjusted to 3 A. In Configuration 14-1 and Configuration 14-2, the first reference value equal to 10 may be obtained according to Equation (1). Accordingly, in Configuration 14-2, the voltage value of the USB port 120_3 may be 12V. Also, the current value of the USB port 120_3 is the quotient of the new power and the voltage value (i.e., 2.5 A).

With respect to Configuration 15-1 and Configuration 15-2, from the configuration information CC1 to CC3 of Configuration 15-1, the common control circuit 140 can determine that the powers of the Type-C ports connected to the external devices are different in step S803. The configuration information CC1 indicates that the USB port 120_1 is the Type-C port having the maximum power (i.e., 45 W). The common control circuit 140 uses the USB port 120_1 as the first USB port and uses the USB port 120_2 as the second USB port.

The common control circuit 140 can determine in step S805 that the power of the USB port 120_1 converted from Configuration 15-1 to Configuration 15-2 (i.e., at the second time) is decreased to be less than or equal to the reserved value T1, and thus perform step S807 to divert the power difference to the second USB port (i.e., the USB port 120_2). In step S807, the common control circuit 140 can determine that the power of the USB port 120_1 is decreased from 45 W to 15 W. In other words, the USB port 120_1 has finished or is about to finish charging (or supplying power) the external device. Therefore, the variation of the power decreased from 45 W to 15 W (i.e., 30 W) is used as the power difference. Next, by using the power difference (i.e., 30 W), the original power of the USB port 120_2 at the second time (i.e., 13.5 W) and the remaining power (i.e., 1.5 W), the common control circuit 140 can calculate the new power (i.e., 30+13.5+1.5=45 W). Accordingly, the power of the USB port 120_2 is increased from 13.5 W to 45 W. For the USB port 120_1, the voltage value is adjusted to 5V, and the current value is adjusted to 3 A. In Configuration 15-1 and Configuration 15-2, the first reference value equal to 15 may be obtained according to Equation (1). Accordingly, in Configuration 15-2, the voltage value of the USB port 120_2 may be 15V. Also, the current value of the USB port 120_2 is the quotient of the new power and the voltage value (i.e., 3 A).

Sufficient teachings regarding Configuration 16-1 and Configuration 16-2 may be obtained from the description for Configuration 15-1 and Configuration 15-2, which is not repeated hereinafter.

The following refers back to step S702 of the third embodiment shown in FIG. 1, and FIG. 7 to FIG. 10. In step S702, if it is determined that at least one of the USB ports 120_1 to 120_3 and the USB port 120_4 are respectively connected to the external devices, the common control circuit 140 proceeds to step S703. In step S703, the common control circuit 140 determines whether the at least one of the Type-C ports (i.e., the USB ports 120_1 to 120_3) is connected to the external device first. If it is determined that the at least one of the Type-C ports is connected to the external device first, the common control circuit 140 proceeds to step node D.

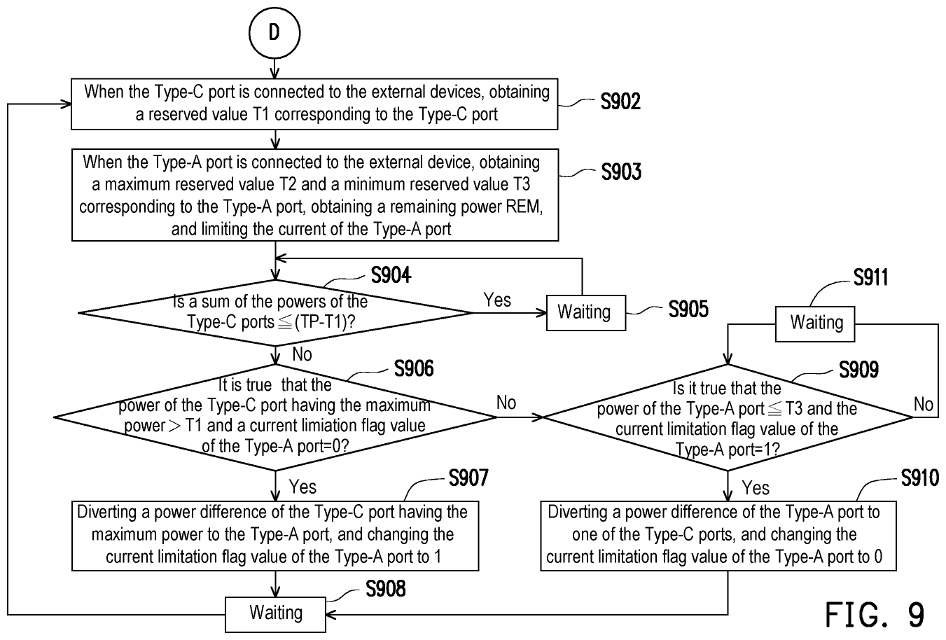

Next, in step S902 of FIG. 9, the common control circuit 140 obtains a reserved value T1 corresponding to the Type-C port when the Type-C port is connected to the external device.

The common control circuit 140 determines whether the Type-A port is connected to the external device through the Type-A port (i.e., the USB port 120_4). It should be understood that in step S902, the common control circuit 140 can also perform the operations of steps S802 to S808. In step S903, the Type-A port is connected to the external device. When the Type-A port is connected to the external device, the common control circuit 140 obtains a maximum reserved value T2 and a minimum reserved value T3 corresponding to the Type-A port, and obtains the remaining power REM.

In this embodiment, the maximum reserved value T2 is a product of a minimum rated voltage of the Type-A port and a maximum rated current of the Type-A port. The minimum reserved value T3 is a product of the minimum rated voltage of the Type-A port and a minimum rated current of the Type-A port. In this embodiment, the minimum rated voltage of the Type-A port is 5V; the maximum rated current of the Type-A port is 2.4 A; and the minimum rated current of the Type-A port is 1 A. Therefore, the maximum reserved value T2 is equal to 12, and the minimum reserved value T3 is equal to 5. The remaining power REM is a difference obtained by subtracting the powers of the USB ports connected to the external devices (including the Type-C port and the Type-A port) from the rated power TP.

Besides, in step S903, when the Type-A port is connected to the external device, the current of the Type-A port is limited, and a current limitation flag value is set to 0. In this embodiment, the current of the Type-A may be limited to be less than or equal to the minimum rated current of the Type-A port (e.g., 0.5 A), but not limited thereto. In this embodiment, a delay time length at which the current limitation flag value is set to 0 needs to be greater than a sustain time length (e.g., 3 seconds). The maintained time length is a shortest time length for performing steps S904 to S907 (i.e., a shortest time required for diverting the power difference).

Next, the common control circuit 140 determines whether a sum of the powers of the Type-C ports is less than or equal to a difference between the rated power TP and the reserved value T1 in step S904. If the common control circuit 140 determines that the sum of the powers of the Type-C ports is less than or equal to the difference between the rated power TP and the reserved value T1 (i.e., the Type-A port can receive sufficient power of the output electric energy P4), there is no need to divert the output electric energy. Accordingly, the common control circuit 140 waits in step S905. For instance, the common control circuit 140 can wait for (but not limit to) 10 minutes before returning to step S904. Conversely, if the common control circuit 140 determines that the sum of the powers of the Type-C ports is greater than the difference between the rated power TP and the reserved value T1, the output electric energy needs to be diverted. Therefore, the common control circuit 140 can determine whether the power of the Type-C port having the maximum power is greater than the reserved value T1 and whether the current limitation flag value of the Type-A port=0 in step S906. If a determination result of the above is “Yes”, the Type-A port is in a state of a current limitation and the Type-C port having the maximum power includes the sufficient power to be diverted to the Type-A port. Therefore, in step S907, the common control circuit 140 releases the current limitation of the Type-A port, diverts the power difference of the Type-C port having the maximum power to the Type-A port, changes the current limitation flag value of the Type-A port to 1, and proceeds to step S908 once the diverting is completed. For instance, the common control circuit 140 can wait for (but not limit to) 10 minutes before returning to step S902. In an embodiment, the current limitation flag value may also be changed from 1 to 0.

In step S907, as an example, for the USB port 120_4, the voltage value is fixed to 5V, and the current value is adjusted from the limited 0.5 A to 2.4 A.

In step S907, the common control circuit 140 can also calculate a voltage value and a current value of the new output power by using the power of the Type-C port having the maximum power at the second time, the maximum reserved value T2 and the remaining value REM. The common control circuit 140 controls the power converters 130_1 to 130_4 to configure a new power to the second USB port after the second time. Specifically, the common control circuit 140 can obtain a second reference value according to Equation (2).

N2=(P3′−T2+REM)/IP Equation (2)

Here, N2 is the second reference value, and P3′ is the power of the Type-C port having the maximum power at the second time. The second reference value may be a positive integer or a positive real number.

Based on the second reference value in different ranges, the common control circuit 140 can provide the corresponding voltage value to the Type-C port having the maximum power before the second time. In an embodiment, based on the second reference value in different ranges, the common control circuit 140 can provide the corresponding voltage value to any other Type-C port. Sufficient teachings regarding implementation details of the corresponding voltage value provided based on the second reference value in different ranges may be obtain from implementation details of the first reference value, which are not repeated hereafter.

Returning to step S906, if the determination result of the above is “No”, step S909 is performed. In step S909, the common control circuit 140 determines whether the power of the Type-A port is less than or equal to the minimum reserved value T3 and whether the current limitation flag value of the Type-A port is equal to 1. If a determination result of the above is “Yes”, the current limitation of the Type-A port is released and the power of the Type-A port is decreased to be less than or equal to the minimum reserved value T3. In other words, the Type-A port has finished or is about to finish charging (or supplying power) the external device.

In step S910, the common control circuit 140 diverts the power difference of the Type-A port to one of the Type-C port, changes the current limitation flag value of the Type-A port to 0, and proceeds to step S908 once the diverting is completed.

In step S908, as an example, for the USB port 120_4, the voltage value is fixed to 5V, and the current value is adjusted form 2.4 A to 1 A.

In step S910, the common control circuit 140 can also calculate a voltage value and a current value of the new output power by using the power of the Type-C port having the maximum power at the second time, the maximum reserved value T2 and the remaining value REM. The common control circuit 140 controls the power converters 130_1 to 130_4 to configure a new power to the second USB port after the second time. Specifically, the common control circuit 140 can obtain a third reference value according to Equation (3).

N3=(P3′+T2−P4′+REM)/IP Equation (3)

Here, N3 is the third reference value, and P4′ is the power of the Type-A port at the second time. The third reference value may be a positive integer or a positive real number.

Based on the third reference value in different ranges, the common control circuit 140 can provide the corresponding voltage value to the Type-C port having the maximum power before the second time. In an embodiment, based on the third reference value in different ranges, the common control circuit 140 can provide the corresponding voltage value to any other Type-C port. Sufficient teachings regarding implementation details of the corresponding voltage value provided based on the third reference value in different ranges may be obtain from implementation details of the first reference value, which are not repeated hereafter.

Returning to step S909, if the determination result is “No”, step S911 is performed to start waiting. For instance, the common control circuit 140 can wait for (but not limit to) 10 minutes before returning to step S909.

Table 3 illustrates a power supply comparison table of the multi-port power supply apparatus according to an embodiment of the invention.

TABLE 3

| | | | | | Current |
|---|---|---|---|---|---|
| | | | | | limita- |
| | | | | | tion |
| Config- | CC1 | CC2 | CC3 | CC4 | flag |
| uration | (Type-C) | (Type-C) | (Type-C) | (Type-A) | value |
| 17 | 5 V/3 A | 5 V/3 A | 5 V/3 A | 5 V/2.4 A | 0 |
| 18 | 9 V/3 A | 9 V/2 A | 5 V/3 A | 5 V/0.5 A | 1 |
| | converted | | | converted | |
| | into | | | into | |
| | 5 V/3 A | | | 5 V/2.4 A | |
| 19 | 12 V/3 A | 9 V/1 A | 5 V/3 A | 5 V/0.5 A | 1 |
| | converted | | | converted | |
| | into | | | into | |
| | 9 V/2.6 A | | | 5 V/2.4 A | |
| 20 | 15 V/3 A | 5 V/3 A | | 5 V/0.5 A | 1 |
| | converted | | | converted | |
| | into | | | into | |
| | 12 V/2.7 A | | | 5 V/2.4 A | |
| 21 | 20 V/2.5 A | 9 V/1 A | | 5 V/0.5 A | 1 |
| | converted | | | converted | |
| | into | | | into | |
| | 15 V/2.6 A | | | 5 V/2.4 A | |
| 22 | 20 V/3 A | | | 5 V/0.5 A | 1 |
| | converted | | | converted | |
| | into | | | into | |
| | 20 V/2.4 A | | | 5 V/2.4 A | |
| 23 | 5 V/3 A | 9 V/2 A | 5 V/3 A | 5 V/2.4 A | 0 |
| | | converted | | converted | |
| | | into | | into | |
| | | 9 V/2.7 A | | 5 V/1 A | |
| 24 | 9 V/2.6 A | 9 V/1 A | 5 V/3 A | 5 V/2.4 A | 0 |
| | converted | | | converted | |
| | into | | | into | |
| | 12 V/2.6 A | | | 5 V/1 A | |
| 25 | 12 V/2.7 A | 5 V/3 A | | 5 V/2.4 A | 0 |
| | converted | | | converted | |
| | into | | | into | |
| | 15 V/2.6 A | | | 5 V/1 A | |
| 26 | 15 V/2.6 A | 9 V/1 A | | 5 V/2.4 A | 0 |
| | converted | | | converted | |
| | into | | | into | |
| | 20 V/2.3 A | | | 5 V/1 A | |
| 27 | 20 V/2.4 A | | | 5 V/2.4 A | 0 |
| | converted | | | converted | |
| | into | | | into | |
| | 20 V/2.75 A | | | 5 V/1 A | |

Examples are provided below for further description. Referring to FIG. 1, FIG. 9 and Table 3 together, in this example, a time point at which the Type-C ports (i.e., the USB ports 120_1 to 120_3) are connected to the external device is earlier than a time point at which the Type-A port (i.e., the USB port 120_4) is connected to the external device. When the Type-A port is connected to the external device, the current of Type-A port is limited. Accordingly, for the Type-A port, the voltage value is 5V, and the current value is 0.5 A. The power of the Type-A port is 2.5 W. Also, at this time point, the current limitation flag value of the Type-A port is set to 0.

With respect to Configuration 17, the common control circuit 140 can determine in step S904 that the sum of the powers of the Type-C ports (i.e., 45 W) is equal to the difference between the rated power TP and the reserved value T1 (i.e., 45 W). Accordingly, there is no need to divert the output electric energies P1 to P4.

With respect to Configuration 18, the common control circuit 140 can determine in step S904 that the sum of the powers of the Type-C ports (i.e., 60 W) is greater than the difference between the rated power TP and the reserved value T1 (i.e., 45 W), and thus proceed to step S906. In step S906, the common control circuit 140 can determine that the power (i.e., 27 W) of the Type-C port having the maximum power (i.e., the USB port 120_1) is greater than the reserved value T1 (i.e., 15 W), determine that the current limitation flag value is equal to 0, and thus proceed to step S907. In step S907, the common control circuit 140 can control the power converter 130_4 to release the current limitation of the Type-A port, and control the power converters 130_1 and 130_4 to divert the power difference of the USB port 120_1 to the Type-A port. Specifically, the power of the USB port 120_1 is decreased from 27 W to 12 W so that the power is decreased to 15 W (i.e., the new power). The 12 W subtracted is the power difference. The Type-A port can receive the power difference to thereby increase the current value of the Type-A port from 0.5 A to 2.4 A. Next, the current limitation flag value is set to 1.

Further, with respect to Configuration 18, the second reference value equal to 5 may be obtained according to Equation (2). Accordingly, the voltage value of the USB port 120_1 may be adjusted to 5V. Also, the current value of the USB port 120_1 is the quotient of the new power and the voltage value (i.e., 3 A).

With respect to Configuration 19 to Configuration 22, sufficient teachings regarding the processes in Configuration 19 to Configuration 22 may be obtained from the description for Configuration 18, which is not repeated hereinafter.

With respect to Configuration 23, the common control circuit 140 can determine in step S904 that the sum of the powers of the Type-C ports (i.e., 48 W) is greater than the difference between the rated power TP and the reserved value T1 (i.e., 45 W), and thus proceed to step S906. In step S906, the common control circuit 140 can determine that the power (i.e., 18 W) of the Type-C port having the maximum power (i.e., the USB port 120_2) is greater than the reserved value T1 (i.e., 15 W), determine that the current limitation flag value is equal to 1, and thus proceed to step S909. In step S909, the common control circuit 140 can determine that the power of the Type-A port is decreased to 5 W (which is already equal to the minimum reserved value T3), determine that the current limitation flag value of the Type-A port is equal to 1, and thus proceed to step S910. In step S910, for the USB port 120_4, the voltage value is fixed to 5V, and the current value is adjusted form 2.4 A to 1 A. Therefore, the power of the USB port 120_4 is decreased from 12 W to 5 W to thereby generate the power difference of 7 W. Thus, the power difference of 7 W is, for example (but not limited to be), diverted to the USB port 120_2. Accordingly, the power of the USB port 120_2 is increased from 18 W to 25 W. Further, with respect to Configuration 23, the third reference value equal to 12.3 may be obtained according to Equation (3). Accordingly, the voltage value of the USB port 120_2 may be adjusted to 9V. Also, the current value of the USB port 120_2 is a quotient of the new power and the voltage value (i.e., 2.7 A).

With respect to Configuration 24 to Configuration 27, sufficient teachings regarding the processes in Configuration 24 to Configuration 27 may be obtained from the description for Configuration 23, which is not repeated hereinafter.

Here, it is worth noting that, in Configuration 23 to Configuration 27, the power difference of the USB port 120_4 is diverted to the Type-C port having the maximum power. In this way, a charging speed for the external device with the high power requirement may be accelerated. In certain embodiments, the power difference may be diverted to the Type-C port having the minimum power, but not limited thereto.

The following refers back to step S703 of the third embodiment shown in FIG. 1, and FIG. 7 to FIG. 10. In step S703, the common control circuit 140 determines whether the at least one of the Type-C ports (i.e., the USB ports 120_1 to 120_3) is connected to the external device first. If it is determined that the Type-A port is connected to the external device first, the common control circuit 140 proceeds to step node E.

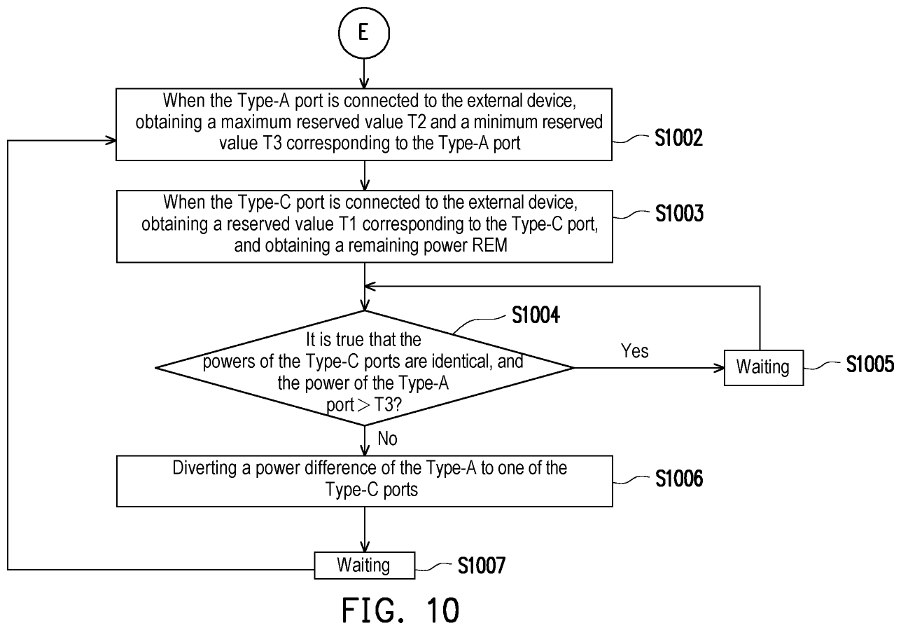

Next, in step S1002 of FIG. 10, when the Type-A port is connected to the external device, the common control circuit 140 obtains the maximum reserved value T2 and the minimum reserved value T3 corresponding to the Type-A port. In step S1003, the Type-C port is connected to the external device. When the Type-C port is connected to the external device, the common control circuit 140 obtains the reserved value T1 corresponding to the Type-C port, and obtains the remaining power REM. Further, in step S1002, because the current of the Type-A port is not limited, the current limitation flag value is set to 1.

In step S1004, the common control circuit 140 determines whether the powers of the Type-C ports are identical, and whether the power of the Type-A port is greater than the minimum reserved value T3. If a determination result of the above is “Yes” (i.e., the power of the Type-A port is still being used and the powers of the Type-C ports of the external device are identical), there is no need to divert the output electric energy so that step S1005 is then performed. In step S1005, the common control circuit 140 waits. For instance, the common control circuit 140 can wait for (but not limit to) 10 minutes before returning to step S1004.

In step S1004, a determination result being “No” means that the power of the Type-A port is decreased to be less than or equal to the minimum reserved value T3 or the power of at least one of the Type-C ports is changed (or not exactly the same). In other words, the Type-A port has finished or is about to finish charging (or supplying power) the external device so the Type-A port can divert the power difference to one of the Type-C ports. In step S1006, the common control circuit 140 sets the current value of the Type-A port from the maximum rated current (e.g., 2.4 A) to the minimum rated current (e.g., 1 A), and diverts the power difference of the Type-A to one of the Type-C ports (e.g., the Type-C port having the maximum power). Sufficient teachings regarding implementation details in step S1006 may be obtained form the description for step S910, which is not repeated hereinafter. Further, in step S1006, because the current of the Type-A port may be regarded as being limited at the minimum rated current, the current limitation flag value is set to 0. Step S1007 is performed once the diverting is completed. In step S1007, the common control circuit 140 waits. For instance, the common control circuit 140 can wait for (but not limit to) 10 minutes before returning to step S1002.

Table 4 illustrates a power supply comparison table of the multi-port power supply apparatus according to an embodiment of the invention.

TABLE 4

| | CC1 | CC2 | CC3 | CC4 |
|---|---|---|---|---|
| Configuration | (Type-C) | (Type-C) | (Type-C) | (Type-A) |
| 28 | 5 V/3 A | 5 V/3 A | 5 V/3 A | 5 V/2.4 A |
| 29 | 9 V/2 A | 9 V/1.5 A | 5 V/3 A | 5 V/2.4 A |
| | into | | | converted |
| | 9 V/2.9 A | | | into |
| | | | | 5 V/1 A |
| 30 | 9 V/2.6 A | 9 V/1 A | 5 V/3 A | 5 V/2.4 A |
| | converted | | | converted |
| | into | | | into |
| | 12 V/2.6 A | | | 5 V/1 A |
| 31 | 12 V/2.7 A | 5 V/3 A | | 5 V/2.4 A |
| | converted | | | converted |
| | into | | | into |
| | 15 V/2.7 A | | | 5 V/1 A |
| 32 | 15 V/2.6 A | 9 V/1 A | | 5 V/2.4 A |
| | converted | | | converted |
| | into | | | into |
| | 20 V/2.3 A | | | 5 V/1 A |
| 33 | 20 V/2.4 A | | | 5 V/2.4 A |
| | converted | | | converted |
| | into | | | into |
| | 20 V/2.7 A | | | 5 V/1 A |

Examples are provided below for further description. Referring to FIG. 1, FIG. 10 and Table 4 together, in this example, a time point at which the Type-A port (i.e., the USB port 120_4) is connected to the external device is earlier than a time point at which the Type-C ports (i.e., the USB ports 120_1 to 120_3) are connected to the external devices.

With respect to Configuration 28, the common control circuit 140 can determine in step S1004 that the powers of the Type-C ports are identical and the power of the Type-A port is greater than the minimum reserved value T3. The output electric energies P1 to P4 will not be diverted.

With respect to Configuration 29, the common control circuit 140 can determine in step S1004 that the powers of the Type-C ports are different. When the power of the Type-A port is decreased from 12 W to 5 W, the power difference of 7 W may be diverted to one of the Type-C ports (e.g., the USB port 120_1). After the power difference is received by the USB port 120_1, according to the power difference and the remaining power (i.e., 1.5 W), the power of the USB port 120_1 is increased from 18 W to 26.5 W. Further, with respect to Configuration 29, the third reference value equal to 8.8 may be obtained according to Equation (3). Accordingly, the voltage value of the USB port 120_1 may be adjusted to 9V. Also, the current value of the USB port 120_1 is the quotient of the new power and the voltage value (i.e., 2.9 A).

With respect to Configuration 30 to Configuration 33, sufficient teachings regarding the processes in Configuration 30 to Configuration 33 may be obtained from the description for Configuration 29, which is not repeated hereinafter.

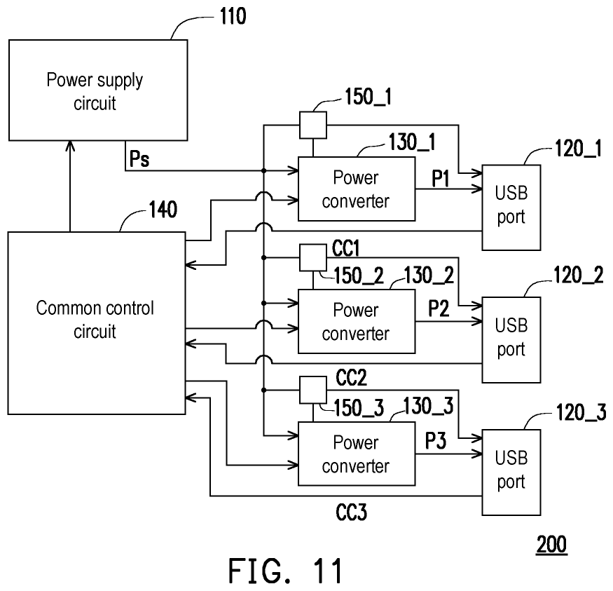

With reference to FIG. 11, FIG. 11 is a circuit block diagram of a multi-port power supply apparatus according to another embodiment of the invention. In this embodiment, a multi-port power supply apparatus 200 includes a power supply circuit 110, USB ports 120_1 to 120_3, power converters 130_1 to 130_3, a common control circuit 140 and bypass switches 150_1 to 150_3. As shown in FIG. 11, the number of the power converters is 3 (i.e., the power converters 130 1 to 130_3); the number of the USB ports is 3 (i.e., the USB ports 120_1 to 120_3); the number of the bypass switches is also 3 (i.e., the bypass switches 150_1 to 150_3). In other embodiments, the number of the power converters, the number of the USB ports and the number of the bypass switches may be adjusted/set according to the design requirements. Sufficient teachings regarding a coupling manner between power supply circuit 110, the USB ports 120_1 to 120_3, the power converters 130_1 to 130_3 and the common control circuit 140 of this embodiment can be obtained from implementation details of FIG. 1, which are not repeated hereinafter.

In the embodiment shown in FIG. 11, first terminals of the bypass switches 150_1 to 150_3 are coupled to the power supply circuit 110 to receive a source electric energy Ps. Second terminals of the bypass switches 150_1 to 150_3 are respectively coupled to power pins of the USB ports 120_1 to 120_3 in a one-to-one manner. Control terminals of the bypass switches 150_1 to 150_3 are respectively coupled to the power converters 130_1 to 130_3 in a one-to-one manner. The bypass switch 150_1 is turned on or off based on the control of the power converter 130_1. Similarly, the bypass switches 150_2 and 150_3 are turned on or off based on the control of the power converters 130_2 and 130_3, respectively. The common control circuit 140 receives configuration information CC1 to CC3 and determines whether to instruct the power converters 130_1 to 130_3 to turn on or off the bypass switches 150_1 to 150_3 according to demand voltage values of the configuration information CC1 to CC3. The bypass switches 150_1 to 150_3 of the present embodiment may be respectively implemented by at least ones transistor switch.

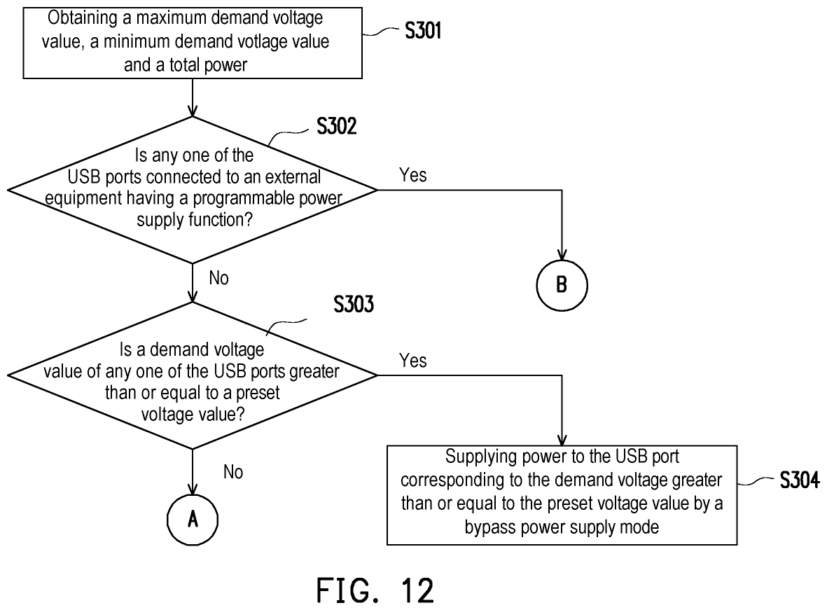

More specifically, referring to FIG. 11 and FIG. 12 together, FIG. 12 is a flowchart illustrating a part of step S230 shown in FIG. 2 according to another embodiment of the embodiment. Step S301, step S302, step node A and step node B shown in FIG. 12 may refer to related description for FIG. 3. Unlike FIG. 3, step S303 and step S304 are further added in the embodiment of FIG. 12.

In this embodiment, the common control circuit 140 obtains the maximum demand voltage value and the minimum demand voltage value among the power requirements of the USB ports 120_1 to 120_3, and calculates the total power according to the power requirements of the USB ports 120_1 to 120_3 in step S301. The common control circuit 140 can determine whether the USB ports 120_1 to 120_3 are connected to the external equipments having the programmable power supply function in step S302. If it is determined in step S302 that any one of the USB ports 120_1 to 120_3 is connected to the external equipment having the programmable power supply function, the common control circuit 140 proceeds to step node B. Conversely, if it is determined in step S302 that none of the USB ports 120_1 to 120_3 is connected to the external equipment having the programmable power supply function, the common control circuit 140 proceeds to step S303.

The common control circuit 140 can compare the demand voltage values of the USB ports 120_1 to 120_3 with a preset voltage value to obtain a comparison result, and determine whether to turn on one or more of the bypass switches 150_1 to 150_3 according to the comparison result. For instance, in step S303, the common control circuit 140 further determines whether the demand voltage values of the USB ports 120_1 to 120_3 are greater than or equal to the preset voltage value (e.g., 20V or other voltage levels). If it is determined that the demand voltage value of any one of the USB ports 120_1 to 120_3 is greater than or equal to the preset voltage value (a determination result of step S303 is “Yes”), the common control circuit 140 proceeds to step S304.

For example, in the case where the demand voltage value of the USB port 120_3 is greater than the preset voltage value (e.g., 20V), the common control circuit 140 instructs the power converter 130_3 to turn on the bypass switch 150_3 in step S304. When the bypass switch 150_3 is turned on, the power converter 130_3 does not perform a power conversion (i.e., the power converter 130_3 does not supply power to the USB port 120_3). Instead, the source electric energy Ps is provided to the power pin of the USB port 120_3 through the turned on bypass switch 150_3 by the power supply circuit 110. A power supply mode described above is referred to as a bypass power supply mode. In other words, the multi-port power supply apparatus 200 can supply power to the USB port with the demand voltage value greater than or equal to the preset voltage value (i.e., the USB port 120_3 according to the example above) by using the source electric energy Ps through the bypass switch in step S304 (the bypass power supply mode). In the case where the USB ports 120_1 to 120_3 have the higher demand voltage values, the power supply circuit 110 provides the source electric energy Ps to the USB ports 120_1 to 120_3 through the turned on bypass switch instead of supplying power to the USB ports 120_1 to 120_3 through the power converters 130_1 to 130_3. In this way, the added bypass switches 150_1 to 150_3 may be used to reduce a voltage loss of the power converters 130_1 to 130_3 during a power transmission and a performance loss during the power conversion performed on the source electric energy.

On the other hand, when determining that the demand voltage values of the USB ports 120_1 to 120_3 are all less than the preset voltage value (e.g., 20V) (the determination result of step S303 is “No), the common control circuit 140 proceeds to step node A (i.e., proceeds to step S402 shown in FIG. 4).

Table 5 illustrates a power supply comparison table of the multi-port power supply apparatus according to an embodiment of the invention.

TABLE 5

| Config- | | | | Total |
|---|---|---|---|---|
| uration | CC1 | CC2 | CC3 | power |
| 34 | 5 V/3 A | 5 V/3 A | 5 V/3 A | 45 W |
| 35 | 5 V/3 A | 9 V/2 A | 15 V/1.8 A | 60 W |
| 36 | 5 V/3 A | 9 V/2 A | 20 V/1.35 A | 60 W |
| | | | (Bypass | |
| | | | power supply | |
| | | | mode) | |
| 37 | 5 V/3 A | 20 V/1 A | 20 V/1 A | 55 W |
| | | (Bypass | (Bypass | |
| | | power supply | power supply | |
| | | mode) | mode) | |
| 38 | 20 V/1 A | 20 V/1 A | 20 V/1 A | 60 W |
| | (Bypass | (Bypass | (Bypass | |
| | power supply | power supply | power supply | |
| | mode) | mode) | mode) | |

Referring to FIG. 11, FIG.12 and Table 5 together, in this embodiment, the power supply comparison table of Table 5 lists examples of various configurations. The preset voltage value of the present embodiment is, for example, 20V. The voltage value of the source electric energy Ps of the present embodiment is, for example, equal to the preset voltage value (i.e., 20V). A current value of the source electric energy Ps of the present embodiment is, for example, 1 A. With respect to Configuration 34 and Configuration 35, the common control circuit 140 can determine in step S304 that the demand voltage values of the USB ports 120_1 to 120_3 are all less than the preset voltage value, and thus proceed to step node A.

With respect to Configuration 36, the common control circuit 140 can determine that the demand voltage value of the USB port 120_3 is equal to the preset voltage value, and thus proceed to step S304. The common control circuit 140 then instructs the power converter 130_3 to turn on the bypass switch 150_3. The multi-port power supply apparatus 200 can supply power to the USB port 120_3 by the bypass power supply mode in step S304, so as to provide the source electric energy Ps to the USB port 120_3 through the turned on bypass switch 150_3. With respect to Configuration 37, the common control circuit 140 can determine that the demand voltage values of the USB ports 120_2 and 120_3 are equal to the preset voltage value, and thus proceed to step S304. The bypass switches 150_2 and 150_3 are then turned on. The multi-port power supply apparatus 200 can supply power to the USB ports 120_2 and 120_3 by the bypass power supply mode in step S304, so as to provide the source electric energy Ps to the USB ports 120_2 and 120_3. With respect to Configuration 38, the common control circuit 140 can determine that the demand voltage values of the USB ports 120_1 to 120_3 are equal to the preset voltage value, and thus proceed to step S304. The bypass switches 150_1 to 150_3 are then turned on. The multi-port power supply apparatus 200 can supply power to the USB ports 120_1 to 120_3 by the bypass power supply mode in step S304, so as to provide the source electric energy Ps to the USB ports 120_1 to 120_3.

In summary, the multi-port power supply apparatus and the operation method in various embodiments of the invention can be used to dynamically divert the power difference between the first power at the first time and the second power at the second time of one USB port to another USB port. The multi-port power supply apparatus and the operation method can also be used to correspondingly control the power supply circuit to dynamically adjust the voltage value of the source electric energy according to the relation between the total power and the threshold power. As a result, the invention can dynamically improve the voltage conversion efficiency of the multi-port power supply apparatus.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

1. A multi-port power supply apparatus comprising:
a plurality of USB ports comprising a first USB port and a second USB port;
a plurality of power converters respectively coupled to the USB ports in a one-to-one manner and configured to supply power to the USB ports; and
a common control circuit coupled to the USB ports to obtain power variations of the USB ports and configured to correspondingly control the power converters to supply power to the USB ports according to power requirements of the USB ports, wherein the common control circuit dynamically diverts a power difference between a first power of the first USB port at a first time and a second power of the first USB port at a second time to the second USB port.

2. The multi-port power supply apparatus according to claim 1, wherein the first time is earlier than the second time, and the first power is greater than the second power.

3. The multi-port power supply apparatus according to claim 2, wherein during a continuous period in which an external device is electrically connected to the second USB port, the common control circuit configures a third power to the second USB port at the first time, and the common control circuit configures a fourth power greater than the third power to the second USB port after the second time.

4. The multi-port power supply apparatus according to claim 1, wherein the first USB port is one USB port having a maximum power among the USB ports at the first time, and the second USB port is one USB port having a minimum power among the USB ports at the first time.

5. The multi-port power supply apparatus according to claim 1, wherein a power of the second USB port at the first time is an original power, the common control circuit calculates a new power by using the original power and the power difference, and the common control circuit controls the power converters to configure the new power to the second USB port after the second time.

6. The multi-port power supply apparatus according to claim 1, wherein a power of the second USB port at the first time is an original power, and the multi-port power supply apparatus further comprises:
a power supply circuit configured to provide a source electric energy to the power converters;
wherein the common control circuit calculates a total power of the USB ports, the common control circuit calculates a remaining power by using a power of the source electric energy and the total power, the common control circuit calculates a new power by using the first power, a reserved value, the original power and the remaining power, and the common control circuit controls the power converters to configure the new power to the second USB port after the second time, wherein the reserved value is a real number.

7. The multi-port power supply apparatus according to claim 6, wherein the reserved value is a product of a minimum rated voltage and a maximum rated current of the first USB port.

8. The multi-port power supply apparatus according to claim 6, further comprising:
a plurality of bypass switches, wherein a first terminal of each of the bypass switches is coupled to the power supply circuit to receive the source electric energy, and second terminals of the bypass switches are respectively coupled to power pins of the USB ports in a one-to-one manner, wherein the common control circuit compares demand voltage values of the USB ports with a preset voltage value to obtain a comparison result, and determines whether to turn on one or more of the bypass switches according to the comparison result.

9. An operation method of a multi-port power supply apparatus, wherein the multi-port power supply apparatus comprises a plurality of USB ports, the USB ports comprise a first USB port and a second USB port, and the operation method comprises:
obtaining power variations of the USB ports by a common control circuit;
correspondingly controlling a plurality of power converters according to power requirements of the USB ports by the common control circuit;
respectively supplying power to the USB ports by the power converters in a one-to-one manner according to a control of the common control circuit; and
dynamically diverting a power difference between a first power of the first USB port at a first time and a second power of the first USB port at a second time to the second USB port by the common control circuit.

10. The operation method according to claim 9, wherein the first time is earlier than the second time, and the first power is greater than the second power.

11. The operation method of claim 10, further comprising:
during a continuous period in which an external device is electrically connected to the second USB port, configuring a third power to the second USB port at the first time by the common control circuit, and configuring a fourth power greater than the third power to the second USB port after the second time by the common control circuit.

12. The operation method according to claim 9, wherein the first USB port is one USB port having a maximum power among the USB ports at the first time, and the second USB port is one USB port having a minimum power among the USB ports at the first time.

13. The operation method according to claim 9, wherein a power of the second USB port at the first time is an original power, and the operation method further comprises:
calculating a new power by using the original power and the power difference by the common control circuit; and
controlling the power converters to configure the new power to the second USB port after the second time by the common control circuit.

14. The operation method according to claim 9, wherein a power of the second USB port at the first time is an original power, and the operation method further comprises:
providing a source electric energy to the power converters by a power supply circuit;
calculating a total power of the USB ports by the common control circuit;
calculating a remaining power by using a power of the source electric energy and the total power by the common control circuit;
calculating a new power by using the first power, a reserved value, the original power and the remaining power by the common control circuit, wherein the reserved value is a real number; and
controlling the power converters to configure the new power to the second USB port after the second time by the common control circuit.

15. The operation method according to claim 14, wherein the reserved value is a product of a minimum rated voltage and a maximum rated current of the first USB port.

16. The operation method of claim 14, further comprising:
comparing demand voltage values of the USB ports with a preset voltage value to obtain a comparison result by the common control circuit; and
determining whether to turn on one or more of the bypass switches according to the comparison result by the common control circuit, wherein a first terminal of each of the bypass switches is coupled to the power supply circuit to receive the source electric energy, and second terminals of the bypass switches are respectively coupled to power pins of the USB ports in a one-to-one manner.

17. A multi-port power supply apparatus comprising:
a power supply circuit configured to provide a source electric energy;
a plurality of USB ports;
a plurality of power converters respectively coupled to the USB ports in a one-to-one manner, wherein the power converters are coupled to the power supply circuit to receive the source electric energy, and the power converters supply power to the USB ports; and
a common control circuit coupled to the USB ports to obtain power requirements of the USB ports and configured to correspondingly control the power converters to supply power to the USB ports according to the power requirements of the USB ports, wherein the common control circuit calculates a total power of the USB ports, and the common control circuit correspondingly controls the power supply circuit to dynamically adjust a voltage of the source electric energy according to a relation between the total power and a threshold power.

18. The multi-port power supply apparatus according to claim 17, wherein the threshold power is a product of a minimum rated voltage and a maximum rated current of the power supply circuit.

19. The multi-port power supply apparatus according to claim 17, wherein when the total power is less than the threshold power, the common control circuit sets a voltage of the source electric energy of the power supply circuit to a minimum rated voltage of the USB ports.

20. The multi-port power supply apparatus according to claim 17, wherein when the total power is greater than or equal to the threshold power and less than or equal to a rated power of the power supply circuit, the common control circuit calculates a quotient of the total power and a maximum rated current of the power supply circuit, and the common control circuit sets a voltage value of the source electric energy of the power supply circuit to the quotient.

21. An operation method of a multi-port power supply apparatus, wherein the multi-port power supply apparatus comprises a plurality of USB ports, and the operation method comprises:
providing a source electric energy to a plurality of power converters by a power supply circuit;
obtaining power requirements of the USB ports by a common control circuit;
calculating a total power of the USB ports by the common control circuit;
correspondingly controlling the power supply circuit to dynamically adjust a voltage of the source electric energy according to a relation between the total power and a threshold power by the common control circuit;
correspondingly controlling the power converters according to the power requirements of the USB ports by the common control circuit; and
respectively supplying power to the USB ports by the power converters according to a control of the common control circuit.

22. The operation method of claim 21, further comprising:
calculating a product of a minimum rated voltage and a maximum rated current of the power supply circuit as the threshold power by the common control circuit.

23. The operation method of claim 21, further comprising:
when the total power is less than the threshold power, setting a voltage of the source electric energy of the power supply circuit to a minimum rated voltage of the USB ports by the common control circuit.

24. The operation method of claim 21, further comprising:
when the total power is greater than or equal to the threshold power and less than or equal to a rated power of the power supply circuit, calculating a quotient of the total power and a maximum rated current of the power supply circuit by the common control circuit, and setting a voltage value of the source electric energy of the power supply circuit to the quotient by the common control circuit.
